(19) United States
(12) Patent Application Publication
(10) Pub. No.: US 2023/0107483 A1
(43) Pub. Date: Apr. 6, 2023

(54) ELECTRICALLY POWERED SUSPENSION SYSTEM

(71) Applicant: HONDA MOTOR CO., LTD., Tokyo (JP)

(72) Inventors: Kazuya KONADA, Wako-shi (JP); Takashi YANAGI, Wako-shi (JP); Ryosuke YAMAZAKI, Wako-shi (JP)

(21) Appl. No.: 17/956,962

(22) Filed: Sep. 30, 2022

(30) Foreign Application Priority Data
Oct. 5, 2021 (JP) 2021-164267

(51) Int. Cl. B60G 17/016

(52) U.S. Cl. CPC B60G 17/016; B60G 2401/16; B60G 2400/60; B60G 2400/20

(57) ABSTRACT

An electrically powered suspension system includes: an electromagnetic actuator that is provided between a vehicle body and a wheel of a vehicle and generates a load for damping vibration of the vehicle body; an information acquisition part that acquires information on a state of a road surface ahead of the vehicle; a target load calculation part that calculates a target load for preview control based on the road surface state, and a load control part that performs load control on the electromagnetic actuator. The target load calculation part estimates an actual input timing based on the vehicle speed and calculates an adjustment start timing related to suspension characteristics, based on the estimated actual input timing. When estimating the actual input timing based on the vehicle speed, the target load calculation part applies, to the vehicle speed, a correction coefficient for correcting a fluctuation of the vehicle speed.

### CROSS-REFERENCE TO RELATED APPLICATIONS

The present application claims the foreign priority benefit under Title 35 U.S.C. § 119 of Japanese Patent Application No. 2021-164267, filed on Oct. 5, 2021, in the Japan Patent Office, the disclosure of which is herein incorporated by reference in its entirety.

### BACKGROUND OF THE INVENTION

### 1. Field of the Invention

The present invention relates to an electrically powered suspension system including an actuator that is provided between a vehicle body and a wheel of a vehicle and configured to generate a load for damping vibration of the vehicle body.

### 2. Description of Related Art

An electrically powered suspension system including an actuator provided between a vehicle body and a wheel of a vehicle and configured to generate a load for damping vibration of the vehicle body is conventionally known. See for example, Japanese Patent Publication No. 2018-134899 (hereinafter referred to as Patent Literature 1).

Known examples of such electrically powered suspension system includes an electrically powered suspension system configured to estimate (preview) the state of the road surface ahead in the direction of advance, predict up-down vibrations of the vehicle body in the future on the basis of the previewed road surface state, and perform preview control that adjusts the suspension characteristics on the basis of the prediction result and the like, thereby to improve the ride quality of the vehicle. See for example, Japanese Patent Publication No. 2020-026187 (hereinafter referred to as Patent Literature 2).

### Problem to be Solved

Incidentally, the electrically powered suspension system described in Patent Literature 2, configured to perform the preview control, consults vehicle speed information for the purpose of synchronizing adjustment start timing related to the suspension characteristics with the timing of an input that actually occurs on the suspension due to the roughness of the road surface.

However, in a case where the vehicle speed information is to be obtained on the basis of a wheel speed, it is difficult to synchronize the adjustment start timing with the actual input timing precisely. This is because the wheel speed has the property of varying from moment to moment according to the roughness of the road surface. If there is a deviation between the actual input timing and the adjustment start timing, the preview control function may possibly fail to work well, in which case the ride quality of the vehicle would be impaired.

### SUMMARY OF INVENTION

The present invention has been made in view of the above-described circumstances, and it is an object of the invention to provide an electrically powered suspension system configured to perform preview control so as to restrain the deviation between the actual input timing and the adjustment start timing, to retain the ride quality of the vehicle at a comfortable level.

To achieve the above-described object, an electrically powered suspension system according to a first aspect of the present invention includes: an actuator provided between a vehicle body and a wheel of a vehicle and configured to generate a load for damping vibration of the vehicle body; an information acquisition part configured to acquire information on a state of a road surface ahead of the vehicle; a target load calculation part configured to calculate a target load for preview control based on the state of the road surface; and a load control part configured to perform load control of the actuator using the calculation result of the target load calculation part. The information acquisition part acquires information on a wheel speed, which is a rotation speed of a wheel provided in the vehicle, and acquires, on the basis of the wheel speed, information on a vehicle speed, which is a traveling speed of the vehicle. The target load calculation part estimates an actual input timing on the basis of the vehicle speed and calculates an adjustment start timing related to suspension characteristics, on the basis of the estimated actual input timing. The load control part performs load control of the actuator with the calculated adjustment start timing. When the target load calculation part estimates the actual input timing on the basis of the vehicle speed, the target load calculation part applies a correction coefficient to the vehicle speed, the correction coefficient configured to correct a fluctuation of the vehicle speed.

The present invention provides an electrically powered suspension system configured to perform preview control so as to restrain the deviation between the actual input timing and the adjustment start timing, to retain the ride quality of the vehicle at a comfortable level.

### BRIEF DESCRIPTION OF THE DRAWINGS

FIG. 1 is a view illustrating an overall configuration of an electrically powered suspension system according to an embodiment of the present invention.

FIG. 2 is a partial cross-sectional view of an electromagnetic actuator included in the electrically powered suspension system according to the embodiment of the present invention.

FIG. 3 is a block diagram illustrating internal and peripheral parts of a load control ECU (Electronic Control Unit) included in the electrically powered suspension system according to the embodiment of the present invention.

FIG. 4 is a block diagram conceptually illustrating an internal configuration of the load control ECU included in the electrically powered suspension system according to the embodiment of the present invention.

FIG. 5A is a conceptual view of the vehicle on which the electrically powered suspension system according to the embodiment of the present invention is installed, as seen from the front of the vehicle.

FIG. 5B is a conceptual view of the vehicle on which the electrically powered suspension system according to the embodiment of the present invention is installed, as seen from the right side of the vehicle.

FIG. 6 is a flowchart for explaining operations of the electrically powered suspension system according to the embodiment of the present invention.

### DETAILED DESCRIPTION OF EMBODIMENTS

An electrically powered suspension system 11 according to an embodiment of the present invention will be described in detail below with reference to the drawings as appropriate.

Note that, in the drawings referenced hereinafter, basically, members having the same function are denoted by the same reference sign. In this case, as a general rule, a redundant description will be omitted. For convenience of explanation, sizes and shapes of members may be schematically illustrated with deformation or in an exaggerated manner.

Herein, the term “actual input timing” means the timing of an input that actually occurs on the suspension due to the roughness of the road surface.

[Basic Configuration Common to Electrically Powered Suspension Systems 11 According to Embodiments of The Present Invention]

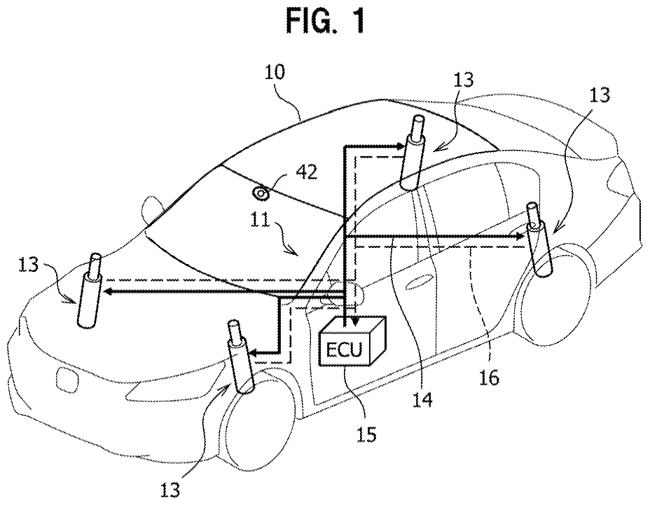

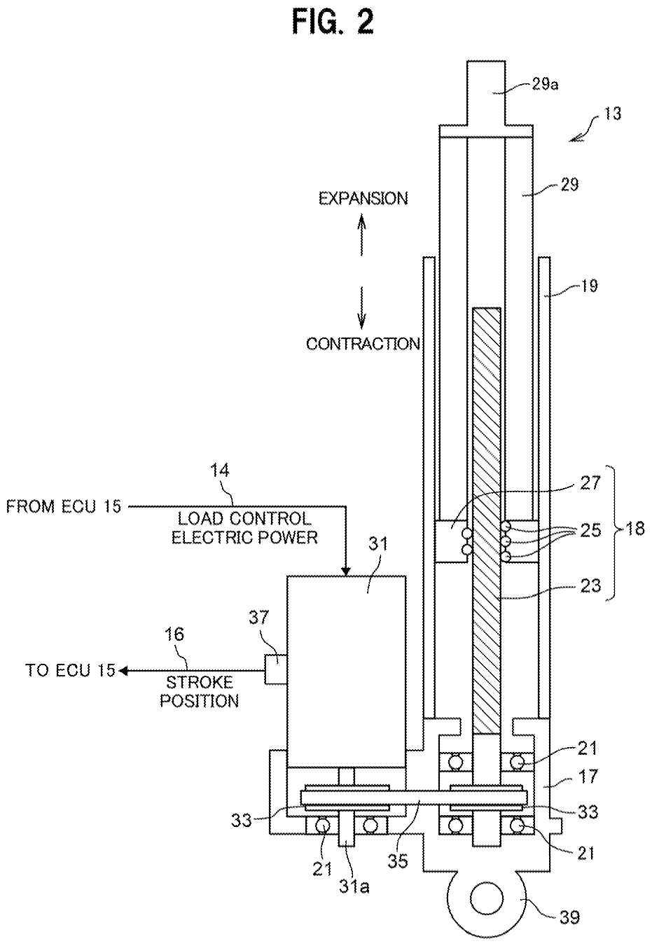

Firstly, a description will be given of a basic configuration common to the electrically powered suspension systems 11 according to the embodiments of the present invention with reference to FIGS. 1 and 2.

FIG. 1 is a view illustrating an overall configuration common to the electrically powered suspension systems 11 according to the embodiments of the present invention. FIG. 2 is a partial cross-sectional view of an electromagnetic actuator 13 included in the electrically powered suspension system 11.

As illustrated in FIG. 1, the electrically powered suspension system 11 according to the embodiment of the present invention includes a plurality of electromagnetic actuators 13 respectively provided to the wheels of a vehicle 10, and a load control ECU 15. The plurality of electromagnetic actuators 13 and the load control ECU 15 are connected to each other with respective electric power supply lines 14 (see the solid lines in FIG. 1) and with respective signal lines 16 (see the broken lines in FIG. 1).

The electric power supply lines 14 are used by the load control ECU 15 to supply load control electric power to the plurality of electromagnetic actuators 13. The signal lines 16 are used by the plurality of electromagnetic actuators 13 to feed load control signals of electric motors 31 (see FIG. 2) to the load control ECU 15.

In the present embodiment, a total of four electromagnetic actuators 13 are provided respectively to the front wheels (front left wheel and front right wheel) and the rear wheels (rear left wheel and rear right wheel). The electromagnetic actuators 13 provided respectively to the wheels are each separately controlled to damp vibration in conjunction with expansion/contraction operations for the corresponding wheel.

In the embodiment of the present invention, unless otherwise noted, the plurality of electromagnetic actuators 13 each have a common configuration. As such, the configuration of one electromagnetic actuator 13 will be described below as a representative of the plurality of electromagnetic actuators 13.

As illustrated in FIG. 2, the electromagnetic actuator 13 includes a base housing 17, an outer tube 19, a ball bearing 21, a ball screw shaft 23, a plurality of balls 25, a nut 27, and an inner tube 29.

The base housing 17 supports a proximal end side of the ball screw shaft 23 via the ball bearing 21 such that the ball screw shaft 23 is rotatable about its axis. The outer tube 19 is provided on the base housing 17 and accommodates a ball screw mechanism 18 including the ball screw shaft 23, the plurality of balls 25, and the nut 27. The plurality of balls 25 roll along a screw groove of the ball screw shaft 23. The nut 27 is engaged with the ball screw shaft 23 via the plurality of balls 25 and converts a rotational motion of the ball screw shaft 23 into a linear motion. The inner tube 29, which is coupled to the nut 27, moves along the axial directions of the outer tube 19 together with the nut 27.

In order to transmit a rotational driving force to the ball screw shaft 23, the electromagnetic actuator 13 includes the electric motor 31, a pair of pulleys 33, and a belt member 35, as illustrated in FIG. 2. The electric motor 31 is provided on the base housing 17 in parallel to the outer tube 19. The pulleys 33 are respectively attached to a motor shaft 31a of the electric motor 31 and the ball screw shaft 23. The belt member 35, which is for transmitting the rotational driving force of the electric motor 31 to the ball screw shaft 23, is wrapped around the pair of pulleys 33.

The electric motor 31 is provided with a resolver 37 that detects a rotation angle signal of the electric motor 31. The rotation angle signal of the electric motor 31, detected by the resolver 37, is fed to the load control ECU 15 via the signal line 16. The rotational driving of the electric motor 31 is controlled in accordance with the load control electric power which is supplied by the load control ECU 15 to the corresponding one of the plurality of electromagnetic actuators 13 via the electric power supply line 14.

As illustrated in FIG. 2, the present embodiment employs a layout in which the motor shaft 31a of the electric motor 31 and the ball screw shaft 23 are arranged substantially in parallel and connected with each other, thereby shortening the axial dimension of the electromagnetic actuator 13. Alternatively, another layout may be employed in which, for example, the motor shaft 31a of the electric motor 31 and the ball screw shaft 23 are coaxially arranged and connected to each other.

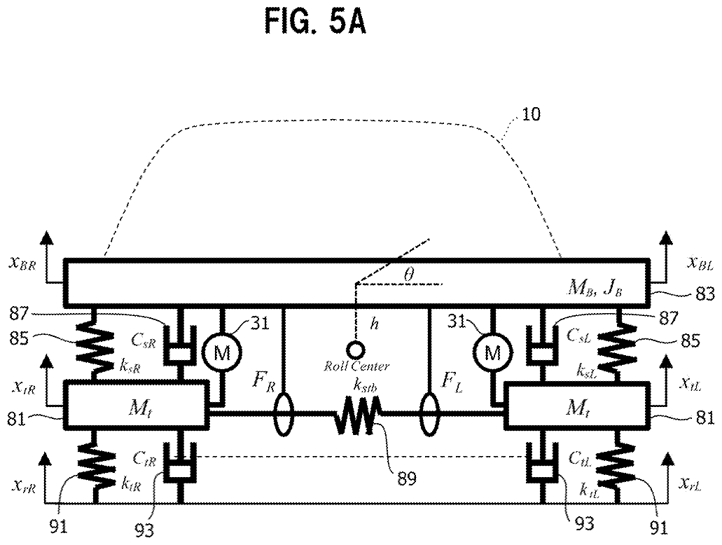

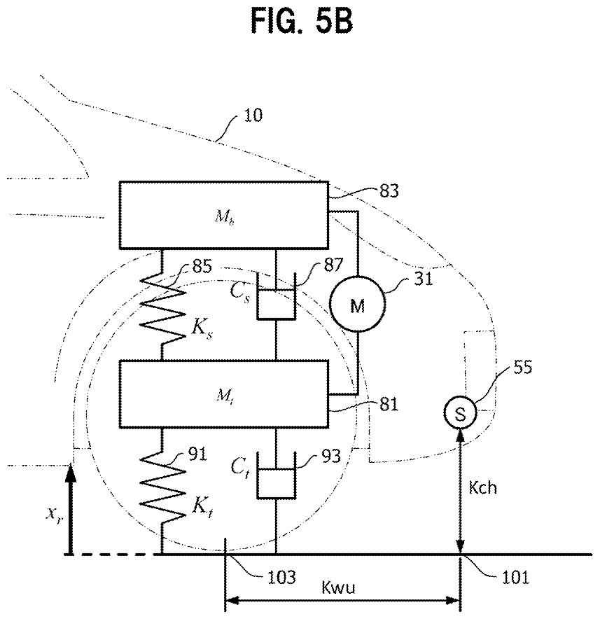

As illustrated in FIG. 2, the electromagnetic actuator 13 according to this embodiment of the present invention has a connecting portion 39 provided at a lower end of the base housing 17. The connecting portion 39 is connected and fixed to an unsprung member 81, non-limiting examples of which unsprung member 81 include a lower arm and a knuckle on the wheel side (see FIGS. 5A and 5B). On the other hand, an upper end portion 29a of the inner tube 29 is connected and fixed to a sprung member 83, non-limiting examples of which sprung member 83 include a strut tower portion on the vehicle body side (see FIGS. 5A and 5B).

In short, the electromagnetic actuator 13 is arranged in parallel with a spring member 85 (see FIGS. 5A and 5B) provided between the sprung member (vehicle body) 83 of the vehicle 10 and the unsprung member 81 (e.g., a wheel to which a tire is attached; hereinafter, sometimes generally called “wheel and the like”) of the vehicle 10. The electromagnetic actuator 13 serves as a virtual damper 87 (see FIGS. 5A and 5B) that buffers the expansion/contraction force of the spring member 85.

As illustrated in FIG. 5A, the unsprung members (wheels and the like) 81 respectively provided to the right and left wheels are connected with each other, for example, via a stabilizer 89 having the shape of a C-shaped rod.

A spring component 91 and a damper component 93 are interposed between the unsprung member (wheel and the like) 81 of the vehicle 10 and the road surface. The tire attached to the wheel of the vehicle 10 functions as the spring component 91 and the damper component 93.

The electromagnetic actuator 13 configured as described above operates as follows. Specifically, consider a case where, for example, a thrust due to upward vibration is inputted into the connecting portion 39 from the wheel side of the vehicle 10. In such a case, the inner tube 29 and the nut 27 attempt to descend together with respect to the outer tube 19, to which the thrust due to the upward vibration has been applied.

In response to this, the ball screw shaft 23 attempts to rotate in a direction to follow the descending of the nut 27. In this event, the electric motor 31 is caused to generate a rotational driving force in a direction in which the rotational driving force impedes the descending of the nut 27. This rotational driving force of the electric motor 31 is transmitted to the ball screw shaft 23 via the belt member 35.

In this manner, the electromagnetic actuator 13 operates to exert a reaction force (attenuation force) on the ball screw shaft 23 against the thrust due to the upward vibration, thereby to attenuate the vibration being to be transmitted from the wheel to the vehicle body.

[Internal Configuration of Load Control ECU 15]

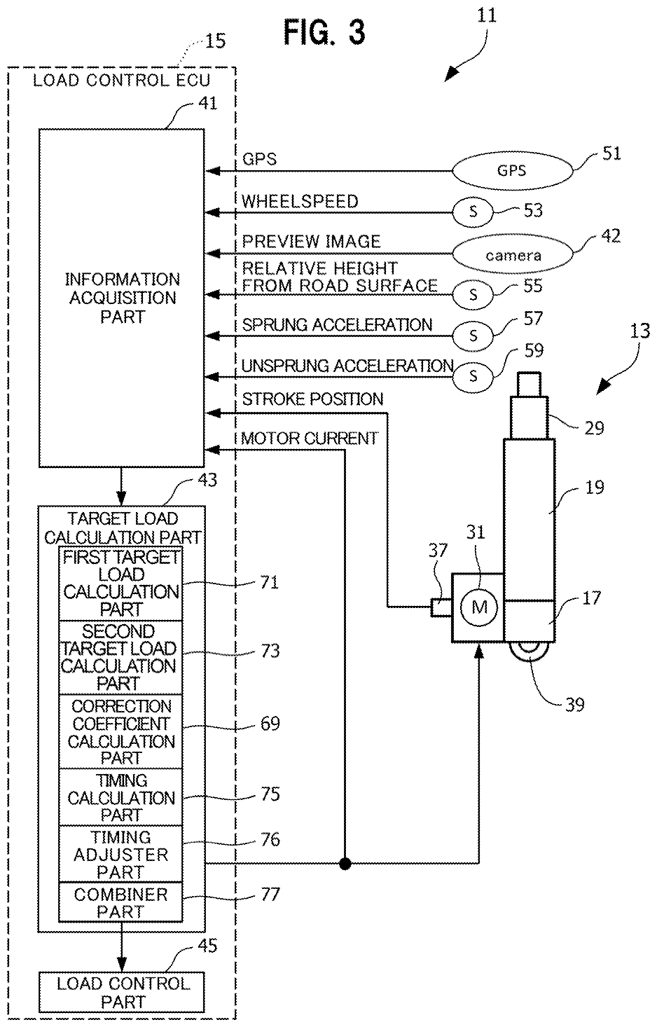

Next, a description will be given of internal and peripheral configurations of the load control ECU 15 included in the electrically powered suspension system 11 according to the embodiment of the present invention, with reference to FIG. 3.

FIG. 3 is a block diagram illustrating internal and peripheral parts of the load control ECU 15 included in the electrically powered suspension system 11 according to the embodiment of the present invention.

[Electrically Powered Suspension System 11 According to Embodiment of The Present Invention]

The load control ECU 15 included in the electrically powered suspension system 11 according to the embodiment of the present invention includes a microcomputer that performs various arithmetic processing operations. The load control ECU 15 performs load control on each of the plurality of electromagnetic actuators 13 on the basis of the rotation angle signal including information on the stroke position of the electric motor 31, detected by the resolver 37, a combined target load (details described below), a motor current to be applied to the electric motor 31, and the like. With this, the load control ECU 15 has a load control function that generates a load for an attenuation operation or an expansion/contraction operation of the electromagnetic actuator 13.

In order to implement such a load control function, the load control ECU 15 includes an information acquisition part 41, a target load calculation part 43, and a load control part 45, as illustrated in FIG. 3.

As illustrated in FIG. 3, the information acquisition part 41 acquires time-series information on GPS (Global Positioning System) and time-series information on the wheel speed. The information on GPS may be acquired through a GPS receiver 51 provided on the vehicle 10. The information on the wheel speed may be acquired through a wheel speed sensor 53.

The information acquisition part 41 also acquires, as time-series information on a road surface state of a road which is located in the advancing direction of the vehicle 10 and on which the vehicle 10 is traveling, information on a preview image and information on a relative height from the road surface. The information on the preview image may be acquired through, in addition to a camera 42 provided on the vehicle 10, external world sensors such as a radar and a LIDAR system. The information on the relative height from the road surface may be acquired, for example, through a vehicle height sensor 55 that detects the relative height of the vehicle 10 from the road surface. Note that the term relative height from the road surface means the relative height of the sprung member (vehicle body) 83 with respect to the road surface.

The information acquisition part 41 further acquires time-series information on a sprung acceleration and time-series information on an unsprung acceleration. The time-series information on the sprung acceleration may be acquired on the basis of detection values of a sprung acceleration sensor 57 provided on the sprung member (vehicle body) 83 of the vehicle 10. The time-series information on the unsprung acceleration may be acquired on the basis of detection values of an unsprung acceleration sensor 59 provided on the unsprung member (wheel and the like) 81 of the vehicle 10.

The information acquisition part 41 further acquires time-series information on the vehicle speed. The time-series information on the vehicle speed may be acquired by a vehicle speed translation part 67 on the basis of detection values of a wheel speed sensor 53. The configurations of the vehicle speed translation part 67 will be described in detail later.

The pieces of time-series information on the GPS position, the vehicle speed, the preview image, the relative height from the road surface, the sprung acceleration, the unsprung acceleration, the stroke position of the electromagnetic actuator 13, and the motor current for the electric motor 31, acquired by the information acquisition part 41, are fed to the target load calculation part 43.

As illustrated in FIG. 3, the target load calculation part 43 has a function of figuring out a combined target load, which is a target value for an attenuation operation or expansion/contraction operation of the electromagnetic actuator 13, and adjustment start timing related to suspension characteristics, by calculation using the various pieces of time-series information acquired by the information acquisition part 41.

The target load calculation part 43 includes a correction coefficient calculation part 69 configured to calculate a correction coefficient for correcting a fluctuation of the vehicle speed, a first target load calculation part 71 configured to calculate a first target load for skyhook control, a second target load calculation part 73 configured to calculate a second target load for preview control, a timing calculation part 75 configured to calculate an adjustment start timing value related to the suspension characteristics, a timing adjuster part 76, and combiner part 77. The configurations of the correction coefficient calculation part 69, the first target load calculation part 71, the second target load calculation part 73, the timing calculation part 75, the timing adjuster part 76, and the combiner part 77 will be described in detail later.

The load control part 45 calculates a target current value that can produce the combined target load figured out by the target load calculation part 43. The load control part 45 then performs drive control on the electric motor 31 included in each of the plurality of electromagnetic actuators 13 so that the motor current for the electric motor 31 will follow the calculated target current value. The combined target load includes the second target load, to which an adjustment start timing adjusted by the timing adjuster part 76 on the basis of the adjustment timing signal fed from the timing calculation part 75 is applied.

The plurality of electromagnetic actuators 13 are controlled separately to perform load control with respective electric motors 31.

[Configuration of Main Part of Load Control ECU 15 Included in Electrically Powered Suspension System 11]

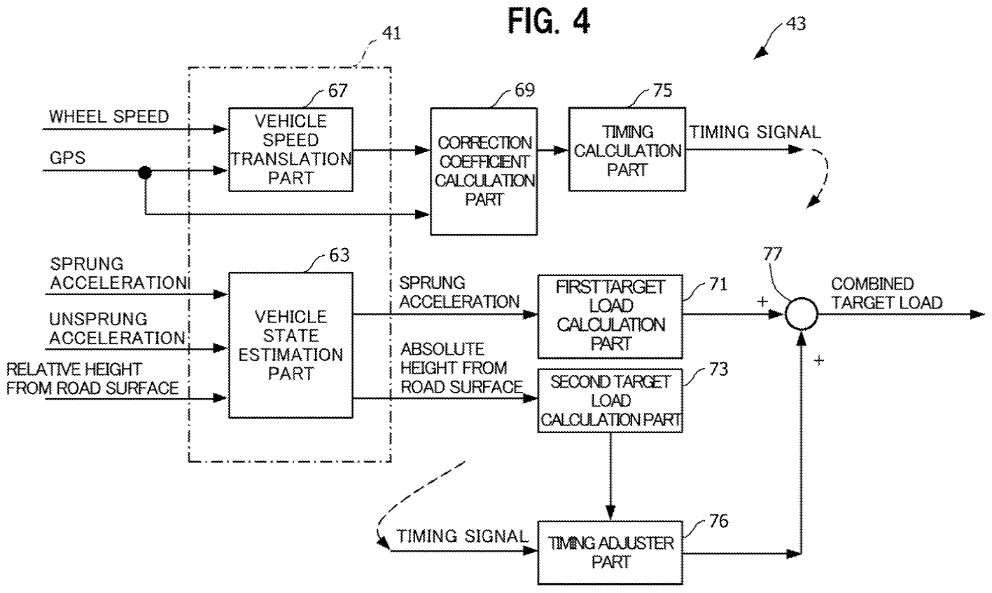

Next, a description will be given of an internal configuration of the load control ECU 15 included in the electrically powered suspension system 11 according to the embodiment of the present invention, with reference to FIGS. 4, 5A, and 5B as appropriate.

FIG. 4 is a block diagram conceptually illustrating an internal configuration of the load control ECU 15 included in the electrically powered suspension system 11 according to the embodiment of the present invention. FIG. 5A is a conceptual view of the vehicle 10 on which the electrically powered suspension system 11 is installed, as seen from the front of the vehicle 10. FIG. 5B is a conceptual view of the vehicle 10 on which the electrically powered suspension system 11 is installed, as seen from the right side of the vehicle 10.

As illustrated in FIG. 4, the load control ECU 15 included the electrically powered suspension system 11 includes: a vehicle state estimation part 63, the vehicle speed translation part 67, the correction coefficient calculation part 69, the first target load calculation part 71, the second target load calculation part 73, the timing calculation part 75, the timing adjuster part 76, and the combiner part 77.

The vehicle state estimation part 63 and the vehicle speed translation part 67 also serve as part of the information acquisition part 41.

The correction coefficient calculation part 69, the first target load calculation part 71, the second target load calculation part 73, the timing calculation part 75, the timing adjuster part 76, and the combiner part 77 are included in the target load calculation part 43.

The vehicle state estimation part 63 estimates, for example, as current vehicle state amounts, a sprung speed as first vehicle state amount (sprung state amount) and a time integral of the sprung speed as second vehicle state amount, on the basis of the time-series information on the sprung acceleration and unsprung acceleration acquired by the information acquisition part 41.

The vehicle state estimation part 63 estimates an absolute height from the road surface on the basis of the time-series information on each of the sprung acceleration, the unsprung acceleration, and the relative height from the road surface, acquired by the information acquisition part 41.

Note that the term absolute height from the road surface means the absolute height of the sprung member (vehicle body) 83 with respect to the road surface.

The relative height from the road surface includes an error due to vehicle body vibrations. The vehicle state estimation part 63 estimates the absolute height from the road surface by subtracting the error from the relative height from the road surface, on the basis of the time-series information on each of the sprung acceleration, the unsprung acceleration, and the relative height from the road surface.

Specifically, the vehicle state estimation part 63 subtracts the current second vehicle state amount (time integral of the sprung speed), estimated by the vehicle state estimation part 63, from a current relative height Kch from the road surface, acquired by the information acquisition part 41. In this way, the absolute height from the road surface is estimated by removing a vehicle height component (error component), which originates in the variation of the sprung speed, from the current relative height Kch from the road surface.

The information on the first vehicle state amount (sprung speed) estimated by the vehicle state estimation part 63 is fed to the first target load calculation part 71.

The information on the absolute height from the road surface, estimated by the vehicle state estimation part 63, is fed to the second target load calculation part 73.

The vehicle speed translation part 67 translates the detection value (wheel speed) of the wheel speed sensor 53 to a vehicle speed. Translation of a wheel speed to a vehicle speed may be performed by, for example, consulting a translation table in which vehicle speed values are specified according to wheel speed values and the external diameter of tires.

The information on the vehicle speed translated value Vcvt, translated by the vehicle speed translation part 67, is fed to the correction coefficient calculation part 69.

The wheel speed fluctuates according to the variations of the external diameter of the tires, which varies due to disturbances, such as variation in the tire air pressure, in the atmosphere temperature, and in the centrifugal force originating from the variation of the vehicle speed. In view of this, in a case where an actual vehicle speed Vrl is to be obtained using the wheel speed-based vehicle speed translated value Vcvt, it is preferable to use the actual vehicle speed Vrl after correcting a fluctuation thereof originating from the fluctuation of the wheel speed.

In view of this, the correction coefficient calculation part 69 is configured to calculate a correction coefficient α for correcting the vehicle speed with respect to a speed fluctuation thereof originating from the fluctuation of the wheel speed. The correction coefficient α may be represented by formula (1).

Correction coefficient α=(GPS speed Vgps)/(vehicle speed translated value Vcvt) (1)

As represented by formula (1), the correction coefficient α is a value that represents a comparison between the GPS speed Vgps, which is a time derivative of positional information of GPS, and the vehicle speed translated value Vcvt.

The information on the correction coefficient α calculated by the correction coefficient calculation part 69 is fed to the timing calculation part 75.

The first target load calculation part 71 calculates a first target load related to skyhook control, on the basis of the first vehicle state amount (sprung speed) estimated by the vehicle state estimation part 63. Specifically, for example, the first target load calculation part 71, using a control rule based on the skyhook theory, multiplies the estimated first vehicle state amount (sprung speed) by a skyhook damping coefficient to calculate the first target load.

The first target load calculated by the first target load calculation part 71 is fed to the combiner part 77.

The second target load calculation part 73 calculates a second target load related to preview control, on the basis of the absolute height from the road surface (actual height from the road surface) estimated by the vehicle state estimation part 63. Specifically, for example, the second target load calculation part 73 multiplies, using a control rule based on the skyhook theory, the absolute height from the road surface (actual height from the road surface) by a preview control gain to calculate the second target load. The second target load calculation part 73 corresponds to the “target load calculation part” of the present invention.

The second target load calculated by the second target load calculation part 73 is fed to the timing adjuster part 76.

The timing calculation part 75 calculates the adjustment start timing related to suspension characteristics, on the basis of the information on the correction coefficient α and the like calculated by the correction coefficient calculation part 69.

Specifically, for example, assume that as a result of monitoring by the vehicle height sensor 55, a rough portion of the road surface is detected at a roughness detection time tdct at a monitoring position 101 (see FIG. 5B). In this event, the timing calculation part 75 calculates (see formula (2)) the adjustment start time tadj, which represents the adjustment start timing related to suspension characteristics, by adding to the roughness detection time tdct a time twu required for the vehicle 10 to advance through the predetermined distance Kwu (see FIG. 5B) from the position 103 (see FIG. 5B) at which the tire is present at the roughness detection time tdct to the monitoring position 101. The required time twu corresponds to a time from the roughness detection time tdct to a time at which the tire starts climbing over the rough portion, which has been detected at the monitoring position 101 at the roughness detection time tdct.

Adjustment start time tadj=roughness detection time tdct+required time twu (2)

Incidentally, the load control ECU 15 determines that a certain level of roughness of the road surface has occurred at the monitoring position 101, when, for example, a temporal variation characteristic value (time derivative) of the relative height Kch from the road surface, detected by the vehicle height sensor 55 sensing the height from the road surface, has exceeded a predetermined threshold value.

Here, the predetermined distance kwu is a value that has been appropriately set on the basis of information such as the installation layout of the vehicle height sensor 55 installed in the vehicle 10 to sense the height from the road surface and the tire layout. The required time twu is calculated on the basis of the predetermined distance Kwu, vehicle speed translated value Vcvt, and the correction coefficient α (see formula (3)).

Required time twu=(predetermined distance Kwu)/((correction coefficient α)×(vehicle speed translated value Vcvt)) (3)

In short, the adjustment start time tadj, which represents adjustment start timing that relates to the suspension characteristics, is corrected in terms of the vehicle speed fluctuation originating from the fluctuation of the wheel speed, using the correction coefficient α.

Information (timing signal) on the adjustment start timing (adjustment start time tadj) that relates to the suspension characteristics, calculated by the timing calculation part 75, is fed to the timing adjuster part 76.

The timing adjuster part 76 adjusts, on the basis of the timing signal (adjustment start time tadj) calculated by the timing calculation part 75, the adjustment start timing related to the suspension characteristics, and applies the adjusted adjustment start timing to the time-series information on the second target load calculated by the second target load calculation part 73. Specifically, the timing adjuster part 76 delays the time-series signal of the second target load by the adjustment start time tadj.

The time-series information on the second target load to which the adjusted adjustment start timing is applied by the timing adjuster part 76 is fed to the combiner part 77.

The combiner part 77 combines, by addition, the first target load calculated by the first target load calculation part 71 and the second target load to which the adjustment start timing adjusted by the timing adjuster part 76, i.e., the adjustment start time tadj, is applied, to calculate a combined target load.

The time-series information on the combined target load combined by the combiner part 77 and including the second target load whose adjustment start timing has been adjusted is fed to the load control part 45.

[Operation of Electrically Powered Suspension System 11]

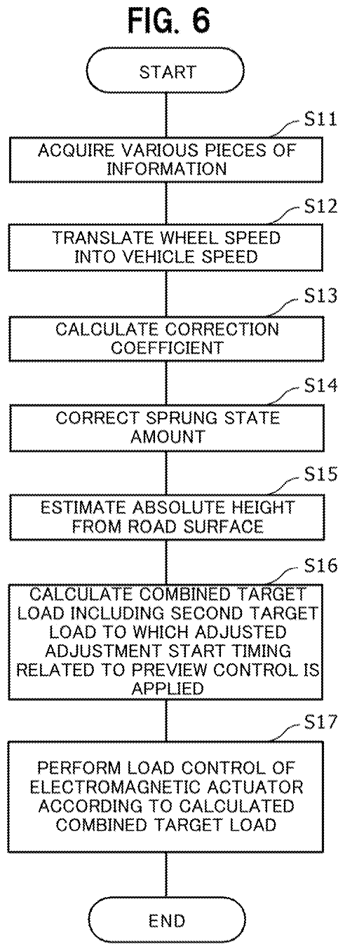

Next, a description will be given of the operations of the electrically powered suspension system 11 according to the embodiment of the present invention with reference to FIG. 6. FIG. 6 is a flowchart for explaining operations of the electrically powered suspension system 11 according to the embodiment of the present invention.

In Step S11 illustrated in FIG. 6, the information acquisition part 41 included in the load control ECU 15 acquires pieces of information including information on the GPS position, the vehicle speed, the preview image, the relative height Kch from the road surface, the sprung acceleration, and the unsprung acceleration.

In Step S12, the vehicle speed translation part 67 of the load control ECU 15 translates the detection value (wheel speed) detected by the wheel speed sensor 53 into a vehicle speed.

In Step S13, the correction coefficient calculation part 69 included in the load control ECU 15 calculates the correction coefficient α for correcting the actual vehicle speed Vrl with respect to a fluctuation thereof originating from the fluctuation of the wheel speed.

In Step S14, the vehicle state estimation part 63 included in the load control ECU 15 estimates a current sprung state amount (first vehicle state amount: sprung speed) on the basis of the time-series information on the sprung acceleration and unsprung acceleration acquired by the information acquisition part 41.

In Step S15, the vehicle state estimation part 63 included in the load control ECU 15 estimates, on the basis of the time-series information on each of the sprung acceleration, the unsprung acceleration, and the relative height Kch from the road surface, acquired by the information acquisition part 41, an absolute height from the road surface, which absolute height is defined as a height obtained by subtracting an error component due to vibrations of the vehicle body from the relative height Kch. Specifically, a vehicle height component (error component) due to the variation in the sprung speed is removed from the relative height Kch from the road surface to obtain the absolute height from the road surface.

In Step S16, the target load calculation part 43 included in the load control ECU 15 calculates the combined target load including the second target load to which the adjusted adjustment start timing related to preview control is applied.

Specifically, the first target load calculation part 71 calculates a first target load related to skyhook control, on the basis of the first vehicle state amount (sprung speed) estimated by the vehicle state estimation part 63. The first target load calculated by the first target load calculation part 71 is a load to mainly reduce vibration that cannot be reduced by the second target load related to the next-described preview control (e.g., vibration due to a factor other than the road surface input).

The second target load calculation part 73 calculates a second target load related to preview control, on the basis of the absolute height from the road surface (actual height from the road surface), estimated by the vehicle state estimation part 63. The second target load calculated by the second target load calculation part 73 is a load to mainly reduce a vibration due to a road surface input.

The timing calculation part 75 calculates the adjustment start timing (adjustment start time tadj) related to suspension characteristics, on the basis of the information on the correction coefficient α and the like calculated by the correction coefficient calculation part 69.

The timing adjuster part 76 adjusts, on the basis of the timing signal (adjustment start time tadj) calculated by the timing calculation part 75, the adjustment start timing related to the suspension characteristics, and applies the adjusted adjustment start timing to the time-series information on the second target load calculated by the second target load calculation part 73. Specifically, the timing adjuster part 76 delays the time-series signal of the second target load by the adjustment start time tadj.

The combiner part 77 combines, by addition, the first target load calculated by the first target load calculation part 71 and the second target load to which the adjustment start timing adjusted by the timing adjuster part 76, i.e., the adjustment start time tadj, is applied, to calculate a combined target load.

In Step S17, the load control part 45 included in the load control ECU 15 performs load control on the electromagnetic actuator 13 according to the combined target load calculated in step S16. As a result, the load control on the electromagnetic actuator 13 reflects the load control according to the second target load to which the adjustment start timing adjusted by the timing adjuster part 76, i.e., adjustment start time tadj, is applied.

After that, the load control ECU 15 completes one cycle of the processes.

[Advantageous Effects of Electrically Powered Suspension System 11 According to Embodiment of Present Invention]

An electrically powered suspension system 11 according to a first aspect includes: an actuator (electromagnetic actuator 13) provided between a vehicle body and a wheel of a vehicle 10 and configured to generate a load for damping vibration of the vehicle body; an information acquisition part 41 configured to acquire information on a state of a road surface ahead of the vehicle 10; a target load calculation part 43 (second target load calculation part 73) configured to calculate a target load (second target load) for preview control based on the road surface, and a load control part 45 configured to perform load control of the electromagnetic actuator 13 using the calculation result of the target load calculation part 43.

The information acquisition part 41 acquires information on a wheel speed, which is a rotation speed of a wheel provided in the vehicle 10, and acquires, on the basis of the wheel speed, information on a vehicle speed, which is a traveling speed of the vehicle 10.

The target load calculation part 43 estimates an actual input timing on the basis of the vehicle speed and calculates an adjustment start timing related to suspension characteristics, on the basis of the estimated actual input timing.

The load control part 45 performs load control of the electromagnetic actuator 13 with the calculated adjustment start timing.

When the target load calculation part 43 estimates the actual input timing on the basis of the vehicle speed, the target load calculation part 43 applies a correction coefficient α to the vehicle speed. The correction coefficient α is configured to correct a fluctuation of the vehicle speed.

The electrically powered suspension system 11 according to the first aspect, when estimating the actual input timing on the basis of the vehicle speed, applies to the vehicle speed the correction coefficient α configured to correct the fluctuation of the vehicle speed. Thus, the electrically powered suspension system 11, which performs preview control, restrains the deviation between the actual input timing and the adjustment start timing, to retain the ride quality of the vehicle 10 at a good level.

An electrically powered suspension system 11 according to a second aspect may be the electrically powered suspension system 11 according to the first aspect, in which the correction coefficient α is a value that represents a comparison between a GPS speed, which is a time derivative of positional information of GPS, and the vehicle speed.

With the electrically powered suspension system 11 according to the second aspect, the correction coefficient α is a value that represents a comparison between a GPS speed, which is a time derivative of positional information of GPS, and the vehicle speed. As a result, it is expected that the deviation between the actual input timing and the adjustment start timing is suitably restrained to retain the ride quality of the vehicle 10 at a comfortable level, compared to the electrically powered suspension system 11 according to the first aspect.

An electrically powered suspension system 11 according to a third aspect may be the electrically powered suspension system 11 according to the first aspect, in which the correction coefficient α is obtained by a comparison with a result of a simulation of the occurrence of a large input exceeding a predetermined threshold.

With the electrically powered suspension system 11 according to the third aspect, the correction coefficient α is obtained by a comparison with a result of a simulation of the occurrence of a large input exceeding a predetermined threshold. As a result, it is expected that the deviation between the actual input timing and the adjustment start timing is restrained to retain the ride quality of the vehicle 10 at a comfortable level, like the electrically powered suspension system 11 according to the first aspect.

An electrically powered suspension system 11 according to a fourth aspect may be the electrically powered suspension system 11 according to any one of the first to third aspects, in which the target load calculation part 43 (second target load calculation part 73) uses, when calculating the target load for the preview control, a two-front-wheel model (see FIG. 5A) that takes a stabilizer 89 into account.

Here, a description will be given of the two-front-wheel model that takes the stabilizer 89 into account, with reference to FIG. 5A.

FIG. 5A defines the two-front-wheel model of performing preview control taking the stabilizer 89 into account so as to eliminate the vibration of the body.

The meaning of the signs used in the two-front-wheel model illustrated in FIG. 5A is as follows:

J_{B} represents the roll moment of inertia of the sprung member (vehicle body) 83; M_{B} represents the mass of the vehicle body 83; Kₛ (K_{sR},K_{sL}) represents the spring constant of the spring member (suspension) 85; Cₛ (C_{sR},C_{sL}) represents the damping coefficient of the virtual damper 87 of the electromagnetic actuator 13; K_{stb} represents the spring constant of the stabilizer 89; θ represents the roll angle of the vehicle body 83; h represents the distance from the roll center to the center of gravity of the vehicle body 83; xₜ (x_{tR}, x_{tL}) represents the vertical shift of the unsprung member (wheel and the like) 81; x_{B} (x_{BR}, x_{BL}) represents the vertical shift of the vehicle body 83; F_{R} represents the thrust (load) of the right electromagnetic actuator 13; and F_{L} represents the thrust (load) of the left electromagnetic actuator 13.

Further, in the two-front-wheel model illustrated in FIG. 5A, Mₜ represents the mass of wheel and the like 81; xᵣ (x_{tR}, x_{rL}) represents the road surface height input; Kₜ (K_{tR}, K_{tL}) represents the spring constant of the unsprung member (tire) 81 (the tires of the two front wheels are assumed to have the same spring constant); Cₜ (C_{tR}, C_{tL}) represents the damping constant of the unsprung member (tire) 81 (the tires of the two front wheels are assumed to have a common damping coefficient value).

According to the two-front-wheel model illustrated in FIG. 5A, an equation of motion in the up-down direction of the body is represented by formula (4); an equation of motion in the rotational direction of the body is represented by formula (5); an equation of motion of the right tire is represented by formula (6); and an equation of motion of the left tire is represented by formula (7).

M_{B}\ddot{x}_{B}+Cₛ(\dot{x}_{BR}−\dot{x}_{tR})+Kₛ(x_{BR}−x_{tR})+Cₛ(\dot{x}_{BL}−\dot{x}_{tL})+Kₛ(x_{BL}−x_{tL})=F_{R}+F_{L} (4)

J_{B}\ddot{θ}+L{Cₛ(\dot{x}_{BR}−\dot{x}_{tR})+Kₛ(x_{BR}−x_{tR})}−L{Cₛ(\dot{x}_{BL}−\dot{x}_{tL})+Kₛ(x_{BL}−x_{tL})}=LF_{R}−LF_{L} (5)

Mₜ\ddot{x}_{tR}+Cₛ(\dot{x}_{tR}−\dot{x}_{BR})+Kₛ(x_{tR}−x_{BR})+Cₜ(\dot{x}_{tR}−\dot{x}_{tR})+Kₜ(x_{tR}−x_{tR})+K_{stb}{(x_{tR}−x_{tL})−(x_{BR}−x_{BL})}=−F_{R} (6)

Mₜ\ddot{x}_{TL}+Cₛ(\dot{x}_{tL}−\dot{x}_{BL})+Kₛ(x_{tL}−x_{BL})+Cₜ(\dot{x}_{tL}−\dot{x}_{rL})+Kₜ(x_{tL}−x_{rL})+K_{stb}{(x_{tL}−x_{tR})−(x_{BL}−x_{BR})}=−F_{R} (7)

Note that, in formula (5), L represents the half length of the tread distance of the vehicle 10.

A Laplace transform is applied to the above equations of motion and variables are substituted with values such that the vibrations of the body is eliminated. That is, x_{BR}=0, x_{BL}=0, and θ=0.

Then, the equations of motion of the body are described as formula (8); and the equations of motion of the tires are described as formula (9).

### Equation of Motion of Body

F_{L}=−(C_{sL}s+K_{sL})X_{tL}

F_{R}=−(C_{sR}s+K_{sR})X_{tR} (8)

### Equation of Motion of Tire

−F_{L}={Mₜs²+(C_{sL}+C_{tL})s+K_{sL}+K_{tL}+K_{stb}}X_{tL}−(C_{tL}+K_{tL})X_{tL}−K_{stb}X_{tR}

−F_{R}={Mₜs²+(C_{sR}+C_{tR})s+K_{sR}+K_{tR}+K_{stb}}X_{tR}−(C_{tR}+K_{tR})X_{tR}−K_{stb}X_{tL} (9)

Note that, in formulas (8) and (9), s denotes a Laplace operator.

Using formulas (8) and (9), the relationship between road surface input Xr and thrust F is represented by the following formula (10):

$$A [ \begin{matrix}{F}_{R} \\ {F}_{L}\end{matrix} ] = [ \begin{matrix}{X}_{rR} \\ {X}_{rL}\end{matrix} ] \qquad ( 10 )$$

where matrix A is represented by the following formula (11).

$$A = [ \begin{matrix}- \frac{\begin{matrix}{M}_{t} {s}^{2} ( {C}_{sR} + {C}_{tR} ) s + \\ {K}_{sR} + {K}_{tR} + {K}_{stb}\end{matrix}}{( {C}_{sR} s + {K}_{sR} ) ( {C}_{tR} s + {K}_{tR} )} + \frac{1}{{C}_{tR} s + {K}_{tR}} & \frac{{K}_{stb}}{( {C}_{sL} s + {K}_{sL} ) ( {C}_{tR} s + {K}_{tR} )} \\ \frac{{K}_{stb}}{( {C}_{sR} s * {K}_{sR} ) ( {C}_{tL} s + {K}_{tL} )} & - \frac{\begin{matrix}{M}_{t} {s}^{2} ( {C}_{sL} + {C}_{tL} ) s + \\ {K}_{sL} + {K}_{tL} + {K}_{stb}\end{matrix}}{( {C}_{sL} s + {K}_{sL} ) ( {C}_{tL} s + {K}_{tL} )} + \frac{1}{{C}_{tL} s + {K}_{tL}}\end{matrix} ] \qquad ( 11 )$$

Therefore, the thrust (load) F that eliminates vibrations of the body is given by the following formula (12).

$$[ \begin{matrix}{F}_{R} \\ {F}_{L}\end{matrix} ] = {A}^{- 1} [ \begin{matrix}{X}_{rR} \\ {X}_{rL}\end{matrix} ] \qquad ( 12 )$$

With the electrically powered suspension system 11 according to the fourth aspect, as illustrated in FIG. 5A, the target load calculation part 43 uses, when calculating the target load for the preview control, the two-front-wheel model (see FIG. 5A) that takes a stabilizer 89 into account. As a result, for example, even when only one of the right and left tires runs on a step, the electrically powered suspension system 11, while sufficiently restraining the sprung vibrations, restrains the vibrations of the other tire, compared to the electrically powered suspension system 11 according to any one of the first to third aspects.

As a result, the electrically powered suspension system 11 according to the fourth aspect improve the effect of retaining the ride quality of the vehicle 10 at a comfortable level, compared to the electrically powered suspension system 11 according to any one of the first to third aspects.

### OTHER MODIFICATIONS

The plurality of embodiments described above represent examples of embodying the present invention. Therefore, the technical scope of the present invention should not be construed to be limited to these embodiments. The present invention can be implemented in various embodiments without departing from the gist or the main scope of the present invention.

For example, the electrically powered suspension systems 11 according to the embodiments of the present invention have been described with an exemplary embodiment in which a total of four electromagnetic actuators 13 are arranged for both the front wheels (front left wheel and front right wheel) and the rear wheels (rear left wheel and rear right wheel). However, the present invention is not limited to this configuration. A total of two electromagnetic actuators 13 may be arranged in either the front wheels or the rear wheels.

In addition, the electrically powered suspension systems 11 according to the embodiments of the present invention have been described such that a load control part 45 performs load control on each of a plurality of electromagnetic actuators 13 separately. Specifically, the load control part 45 is configured to perform load control on each of electromagnetic actuators 13 provided respectively on the four wheels, separately.

Alternatively, the load control part 45 may be configured to perform load control of electromagnetic actuators 13 provided respectively on the four wheels, separately for the front wheels and for the rear wheels, or separately for the right wheels and the left wheels.

Lastly, although the electrically powered suspension systems 11 according to the exemplary embodiments of the present invention have been described with the electromagnetic actuator 13 having a ball screw type actuator as the drive mechanism, the present invention is not limited thereto.

The drive mechanism of the electromagnetic actuator 13 may be of any type, non-limiting examples of which include the linear motor type, the rack and pinion type, and the rotary type.

What is claimed is:

1. An electrically powered suspension system comprising:
an actuator provided between a vehicle body and a wheel of a vehicle and configured to generate a load for damping vibration of the vehicle body;
an information acquisition part configured to acquire information on a state of a road surface ahead of the vehicle;
a target load calculation part configured to calculate a target load for preview control based on the state of the road surface; and
a load control part configured to perform load control of the actuator using the calculation result of the target load calculation part,
wherein the information acquisition part acquires information on a wheel speed, which is a rotation speed of a wheel provided in the vehicle, and acquires, on the basis of the wheel speed, information on a vehicle speed, which is a traveling speed of the vehicle,
wherein the target load calculation part estimates an actual input timing on the basis of the vehicle speed and calculates an adjustment start timing related to suspension characteristics, on the basis of the estimated actual input timing,
wherein the load control part performs load control of the actuator with the calculated adjustment start timing, and
wherein when the target load calculation part estimates the actual input timing on the basis of the vehicle speed, the target load calculation part applies a correction coefficient to the vehicle speed, the correction coefficient configured to correct a fluctuation of the vehicle speed.

2. The electrically powered suspension system according to claim 1,
wherein the correction coefficient is a value that represents a comparison between a GPS speed, which is a time derivative of positional information of GPS, and the vehicle speed.

3. The electrically powered suspension system according to claim 1,
wherein the correction coefficient is obtained by a comparison with a result of a simulation of an occurrence of a large input exceeding a predetermined threshold.

4. The electrically powered suspension system according to claim 1,
wherein the target load calculation part uses, when calculating the target load for the preview control, a two-front-wheel model that takes a stabilizer into account.

5. The electrically powered suspension system according to claim 2,
wherein the target load calculation part uses, when calculating the target load for the preview control, a two-front-wheel model that takes a stabilizer into account.

6. The electrically powered suspension system according to claim 3,
wherein the target load calculation part uses, when calculating the target load for the preview control, a two-front-wheel model that takes a stabilizer into account.
